(19) United States
(12) Patent Application Publication
(10) Pub. No.: US 2022/0041199 A1
(43) Pub. Date: Feb. 10, 2022

(54) ROUND-UP FOLDABLE HANDCART

(71) Applicant: Pengfei TONG, Jinhua (CN)

(72) Inventor: Pengfei TONG, Jinhua (CN)

(21) Appl. No.: 17/506,950

(22) Filed: Oct. 21, 2021

(30) Foreign Application Priority Data
Sep. 7, 2021 (CN) 202122151172.7

(51) Int. Cl. B62B 3/02

(52) U.S. Cl. CPC B62B 3/025; B62B 2205/06; B62B 2205/04

(57) ABSTRACT

A round-up foldable handcart includes left, right, front and rear upright columns, front and rear folding frames, left and right folding frames and a folding base. The left, right, front and rear upright columns are provided with wheels and fixedly provided with front and rear fixed seats, a front base and a rear base; front and rear sliding seats are arranged at the middle; the front and rear folding frames are hinged to the front and rear fixed seats and the front and rear sliding seats at the front and rear sides; the left and right folding frames are hinged to the front and rear fixed seats and the front and rear sliding seats at the left and right sides; the folding base includes front and rear base connecting rods, a handle, and front and rear hinging seats fixed at both ends of the handle.

### CROSS-REFERENCE TO RELATED APPLICATIONS

This application claims the benefit of priority from Chinese Patent Application No. 202122151172.7, filed on Sep. 7, 2021. The content of the aforementioned application, including any intervening amendments thereto, is incorporated herein by reference in its entirety.

### TECHNICAL FIELD

The disclosure relates to the technical field of manually operated goods trolleys, in particular to a round-up foldable handcart featured with rapid folding and convenient storage.

### BACKGROUND OF THE PRESENT INVENTION

With the increase of economic income and the enhancement and improvement of living conditions of people, activities such as family shopping, road trip or camping in the countryside have been continuously increased. To facilitate shopping or hauling in the wild, many consumers take shopping trolleys as auxiliary tools and drag articles directly on the shopping trolleys, to greatly alleviate worries about carrying various bags in the hands. However, the existing shopping trolleys in the market have the following problems during use: firstly, the shopping trolleys are low in load capacity, able to accommodate fewer goods, and unable to meet the requirements of the consumers for storing goods due to the limitations of shapes and volumes; secondly, the shopping trolleys are light in structure, low in mechanical strength, relatively poor in stability of the overall structure, unreliable to use, and unable to be dragged on rural roads with poor road conditions; and thirdly, the shopping trolleys are inconvenient to be folded by round-up, carried and stored. In view of the above problems, many manufacturers and insightful people have performed development and trial-production, but a relatively ideal product has been unavailable so far.

### SUMMARY OF THE PRESENT INVENTION

To overcome the above shortcomings in the prior art, a purpose of the disclosure is to provide a round-up foldable handcart featured with reasonable structural design, simple folding operation, stable and reliable use, large load capacity, small volume after folding and convenient carrying and storage.

The following technical solution is adopted in the disclosure to solve the technical problems. The round-up foldable handcart includes front and rear upright columns at left and right sides, front and rear folding frames, left and right folding frames, and a folding base. Front and rear wheels are correspondingly arranged on the left and right front upright columns and the left and right rear upright columns. Front fixed seats and front bases are correspondingly fixed at upper and lower ends of the left and right front upright columns; and front sliding seats are correspondingly arranged at the middle. Rear fixed seats and rear bases are correspondingly fixed at the upper and lower ends of the left and right rear upright columns; and rear sliding seats are correspondingly arranged at the middle. The front and rear folding frames are correspondingly hinged to the front and rear fixed seats and the front and rear sliding seats at front and rear sides. The left and right folding frames are correspondingly hinged to the front and rear fixed seats and the front and rear sliding seats at the left and right sides. The folding base includes front and rear base connecting rods, front and rear hinging seats and a handle. The front and rear hinging seats are correspondingly fixedly connected with both ends of the handle. The front base connecting rod is correspondingly connected among the front hinging seat and the left and right front bases in an upward-folding manner. The rear base connecting rod is correspondingly connected among the rear hinging seat and the left and right rear bases in the upward-folding manner. When the handle is lifted for folding, the front and rear base connecting rods pull the four front and rear upright columns, the front and rear folding frames and the left and right folding frames to be rounded up toward the center; and the four front and rear upright columns, the front and rear folding frames and the left and right folding frames do not scatter when the handcart is lifted.

According to a further solution of the disclosure, the handcart also includes a hand-pulling device. The hand-pulling device includes second steering joints correspondingly fixed on the left and right front upright columns, second steering joints correspondingly hinged on the first steering joints, a hand-pull rod connecting seat and a hand-pull rod connected on the hand-pull rod connecting seat. Hand-pull connecting rods are correspondingly hinged among the hand-pull rod connecting seat and the first steering joints at the left and right sides.

According to the further solution of the disclosure, the front and rear folding frames are formed by hinging two groups of X-shaped folding fork rods.

According to the further solution of the disclosure, the left and right folding frames are formed by hinging two or more groups of X-shaped folding fork rods.

Compared with the prior art, after adopting the above structure, the disclosure has the advantages and effects as follows. Firstly, the length and the width of the disclosure depend on the folding base, while the height depends on the front and rear folding frames and the left and right folding frames, so that handcarts with different lengths, widths and heights can be produced according to the needs of consumers. Secondly, when the handle is lifted for folding, the front and rear base connecting rods can pull the four front and rear upright columns, the front and rear folding frames and the left and right folding frames to be rounded up toward the center; and the four front and rear upright columns, the front and rear folding frames and the left and right folding frames will not scatter when the handle is lifted, so that the handcarts have the advantages of simple and rapid folding, small volume after folding, convenient carrying and storage; when the handcarts are unfolded to use, the handle can further improve the load bearing capacity of the folding base; and the articles are placed on the handcarts more evenly. Thirdly, the handcart body has the advantages of good rigidity, high mechanical strength, good overall stability and large load capacity. Fourthly, since the angle and the direction of the hand-pull rod can be adjusted arbitrarily, to greatly facilitate the dragging of the handcart.

### BRIEF DESCRIPTION OF THE DRAWINGS

FIG. 1 is a schematic diagram of a three-dimensional structure of the disclosure in an unfolded state.

FIG. 2 is a schematic diagram of a three-dimensional structure in another direction of the disclosure in the unfolded state.

FIG. 3 is a schematic diagram of a front view structure of the disclosure in the unfolded state.

FIG. 4 is a schematic diagram of a top view structure of the disclosure in the unfolded state.

FIG. 5 is a schematic diagram of a right view structure of the disclosure in the unfolded state.

FIG. 6 is a schematic diagram of a three-dimensional structure of the disclosure in a folded state.

FIG. 7 is a schematic diagram of a top view structure of the disclosure in the folded state.

In the figures: 1. front fixed seat, 2. hand-pull rod, 3. front folding frame, 4. front upright column, 5. hand-pull rod connecting seat, 6. front wheel, 7. hand-pull connecting rod, 8. front sliding seat, 9. first steering joint, 10. second steering joint, 11. front base, 12. front base connecting rod, 13. front hinging seat, 14. handle, 15. rear hinging seat, 16. rear base connecting rod, 17. rear wheel, 18. rear base, 19. rear sliding seat, 20. left folding frame, 21. rear upright column, 22. rear fixed seat, 23. rear folding frame, 24. right folding frame and 25. X-shaped folding fork rod.

### DETAILED DESCRIPTION OF THE PRESENT INVENTION

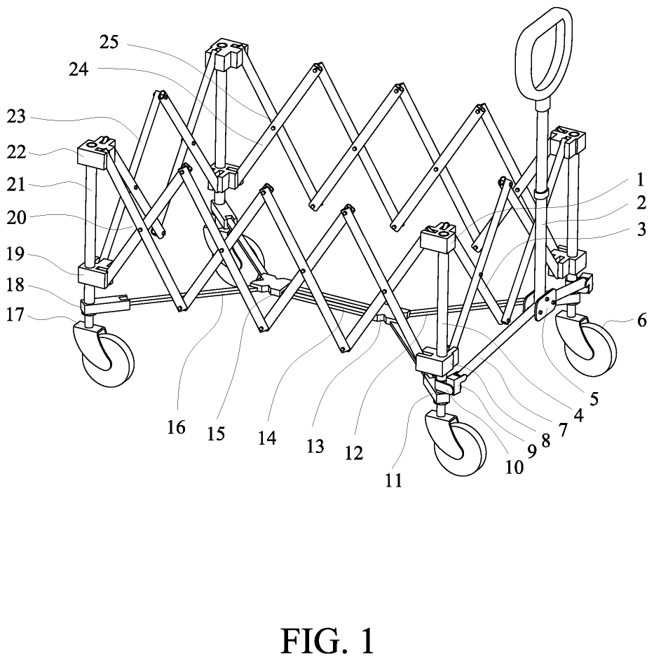

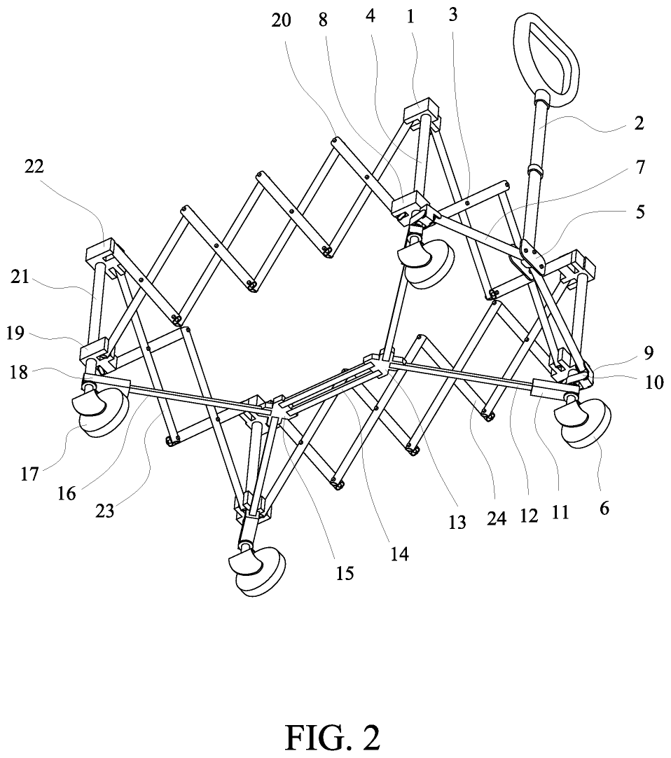

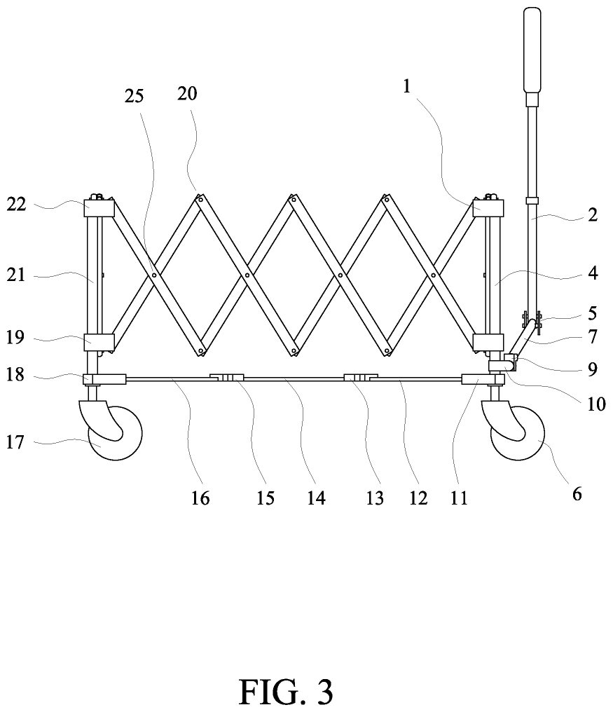

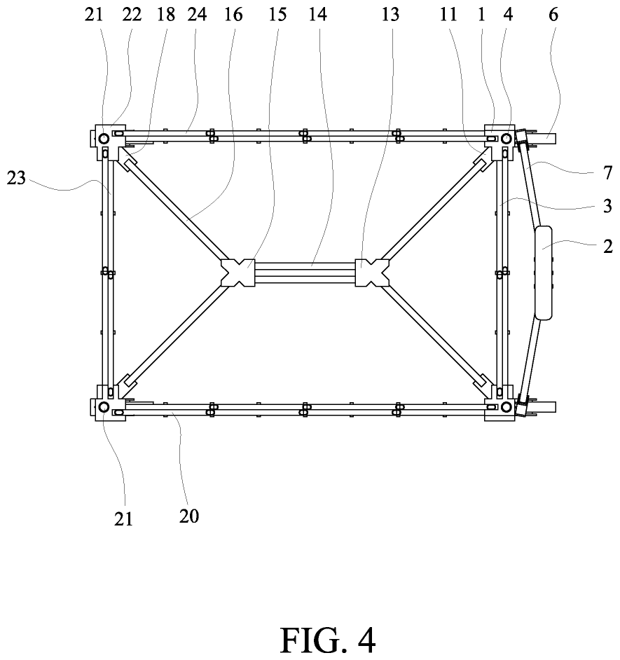

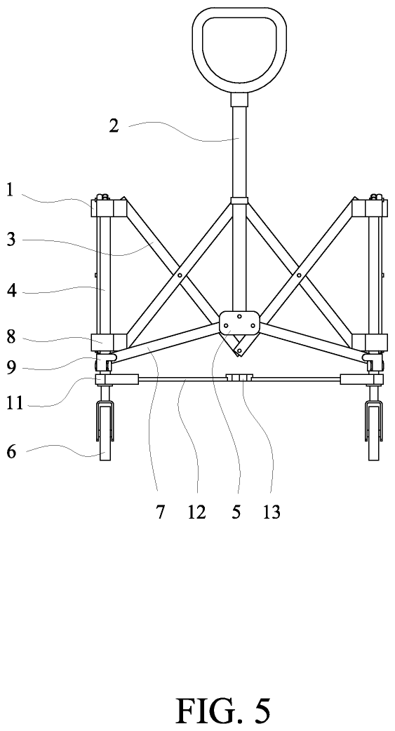

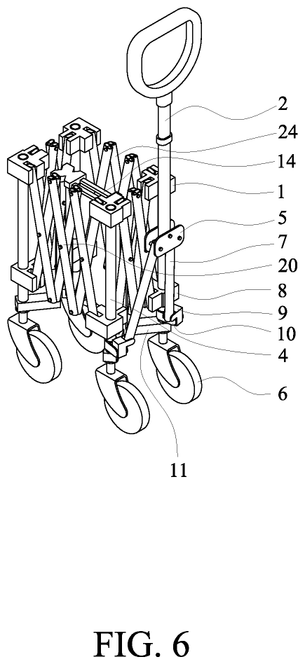

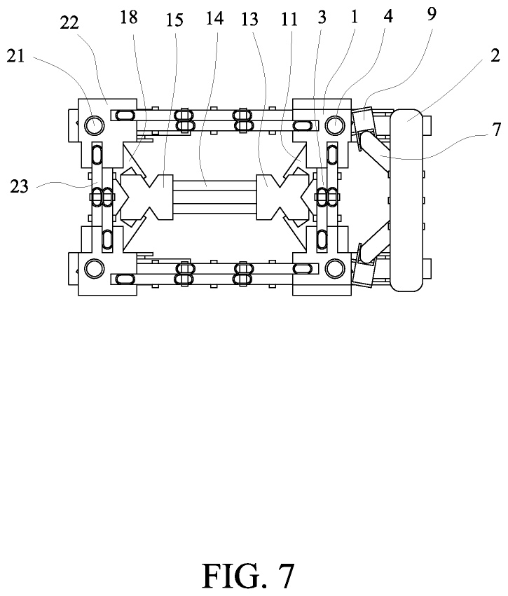

Specific embodiments of the disclosure of a round-up foldable handcart are shown in FIGS. 1-7. The round-up foldable handcart includes front and rear upright columns 4 and 21 at left and right sides, front and rear folding frames 3 and 23, left and right folding frames 20 and 24, and a folding base. Front and rear wheels 6 and 17 are correspondingly arranged on the left and right front upright columns 4 and the left and right rear upright columns 21. Front fixed seats 1 and front bases 11 are correspondingly fixed at upper and lower ends of the left and right front upright columns 4; and front sliding seats 8 are correspondingly arranged at the middle. Rear fixed seats 22 and rear bases 18 are correspondingly fixed at the upper and lower ends of the left and right rear upright columns 21; and rear sliding seats 19 are correspondingly arranged at the middle. The front and rear folding frames 3 and 23 are correspondingly hinged to the front and rear fixed seats 1 and 22 and the front and rear sliding seats 8 and 19 at front and rear sides. The left and right folding frames 20 and 24 are correspondingly hinged to the front and rear fixed seats 1 and 22 and the front and rear sliding seats 8 and 19 at the left and right sides. The folding base includes front and rear base connecting rods 12 and 16, front and rear hinging seats 13 and 15 and a handle 14. The front and rear hinging seats 13 and 15 are correspondingly fixedly connected with both ends of the handle 14. The front base connecting rod 12 is correspondingly connected among the front hinging seat 13 and the left and right front bases 11 in an upward-folding manner. The rear base connecting rod 16 is correspondingly connected among the rear hinging seat 15 and the left and right rear bases 18 in the upward-folding manner. When the handle 14 is lifted for folding, the front and rear base connecting rods 12 and 16 pull the four front and rear upright columns 4 and 21, the front and rear folding frames 3 and 23 and the left and right folding frames 20 and 24 to be rounded up toward the center; and the four front and rear upright columns 4 and 21, the front and rear folding frames 3 and 23 and the left and right folding frames 20 and 24 do not scatter when the handcart is lifted due to the action of gravity, thereby facilitating transportation.

To facilitate movement, the handcart further includes a hand-pulling device. The hand-pulling device includes second steering joints 10 correspondingly fixed on the left and right front upright columns 4, second steering joints 10 correspondingly hinged on the first steering joints 9, a hand-pull rod connecting seat 5 and a hand-pull rod 2 connected on the hand-pull rod connecting seat 5. Hand-pull connecting rods 7 are correspondingly hinged among the hand-pull rod connecting seat 5 and the first steering joints 9 at the left and right sides.

To facilitate folding, the front and rear folding frames 3 and 23 are formed by hinging two groups of X-shaped folding fork rods 25. The left and right folding frames 20 and 24 are formed by hinging two or more groups of X-shaped folding fork rods 25, and are formed by hinging four groups of X-shaped folding fork rods 25 in the present embodiment.

The above only describes an embodiment of the disclosure, and does not limit the disclosure in any form. All simple amendments, equivalent changes or modifications made without departing from the technical solutions of the disclosure shall fall into the protection scope of the disclosure.

What is claimed is:

1. A round-up foldable handcart, comprising front and rear upright columns (4, 21) at left and right sides, front and rear folding frames (3, 23), left and right folding frames (20, 24), and a folding base, wherein front and rear wheels (6, 17) are correspondingly arranged on the left and right front upright columns and the left and right rear upright columns (4, 21); front fixed seats (1) and front bases (11) are correspondingly fixed at upper and lower ends of the left and right front upright columns (4); front sliding seats (8) are correspondingly arranged at the middle; rear fixed seats (22) and rear bases (18) are correspondingly fixed at the upper and lower ends of the left and right rear upright columns (21); rear sliding seats (19) are correspondingly arranged at the middle; the front and rear folding frames (3, 23) are correspondingly hinged to the front and rear fixed seats (1, 22) and the front and rear sliding seats (8, 19) at front and rear sides; the left and right folding frames (20, 24) are correspondingly hinged to the front and rear fixed seats (1, 22) and the front and rear sliding seats (8, 19) at the left and right sides; the folding base comprises front and rear base connecting rods (12, 16), front and rear hinging seats (13, 15) and a handle (14); the front and rear hinging seats (13, 15) are correspondingly fixedly connected with both ends of the handle (14); the front base connecting rod (12) is correspondingly connected among the front hinging seat (13) and the left and right front bases (11) in an upward-folding manner; the rear base connecting rod (16) is correspondingly connected among the rear hinging seat (15) and the left and right rear bases (18) in the upward-folding manner; when the handle (14) is lifted for folding, the front and rear base connecting rods (12, 16) pull the four front and rear upright columns (4, 21), the front and rear folding frames (3, 23) and the left and right folding frames (20, 24) to be rounded up toward the center; and the four front and rear upright columns (4, 21), the front and rear folding frames (3, 23) and the left and right folding frames (20, 24) do not scatter when the handcart is lifted.

2. The round-up foldable handcart according to claim 1, wherein the handcart also comprises a hand-pulling device; the hand-pulling device comprises second steering joints (10) correspondingly fixed on the left and right front upright columns (4), second steering joints (10) correspondingly hinged on the first steering joints (9), a hand-pull rod connecting seat (5) and a hand-pull rod (2) connected on the hand-pull rod connecting seat (5); and hand-pull connecting rods (7) are correspondingly hinged among the hand-pull rod connecting seat (5) and the first steering joints (9) at the left and right sides.

3. The round-up foldable handcart according to claim 2, wherein the front and rear folding frames (3, 23) are formed by hinging two groups of X-shaped folding fork rods (25).

4. The round-up foldable handcart according to claim 1, wherein the left and right folding frames (20, 24) are formed by hinging two or more groups of X-shaped folding fork rods (25).

5. The round-up foldable handcart according to claim 2, wherein the left and right folding frames (20, 24) are formed by hinging two or more groups of X-shaped folding fork rods (25).

6. The round-up foldable handcart according to claim 3, wherein the left and right folding frames (20, 24) are formed by hinging two or more groups of X-shaped folding fork rods (25).
